(19) United States
(12) Patent Application Publication
(10) Pub. No.: US 2023/0019327 A1
(43) Pub. Date: Jan. 19, 2023

(54) POWER STORAGE MODULE

(71) Applicant: Panasonic Intellectual Property Management Co., Ltd., Osaka (JP)

(72) Inventor: HIROTAKA OGINO, Osaka (JP)

(21) Appl. No.: 17/757,405

(22) PCT Filed: Dec. 22, 2020
(86) PCT No.: PCT/JP2020/047886

§ 371 Date: Jun. 15, 2022

(30) Foreign Application Priority Data
Dec. 27, 2019 (JP) 2019-239635

(51) Int. Cl. H01M 10/658; H01G 2/10; H01M 50/213; H01M 50/107; H01M 50/291; H01M 10/643

(52) U.S. Cl. CPC H01M 10/658; H01G 2/103; H01M 50/213; H01M 50/107; H01M 50/291; H01M 10/643; H01M 2220/20

(57) ABSTRACT

A power storage module including: a plurality of power storage devices; and a holder that holds the plurality of power storage devices, wherein each of the power storage devices includes a case including an opening, an electrode assembly accommodated in the case and including a first electrode and a second electrode, and a sealing member that seals the opening, the case includes a cylindrical cylinder part, an opening end part corresponding to the opening provided at one end part of the cylinder part, and a bottom part that closes another end part of the cylinder part, in each of the plurality of power storage devices, at least a part of an outer peripheral surface of the cylinder part is covered with an insulating layer, and positions of a pair of the power storage devices adjacent to each other included in the plurality of power storage devices are regulated by the insulating layer.

### TECHNICAL FIELD

The present disclosure relates to a power storage module.

### BACKGROUND ART

A conventional power storage module generally includes a holder made of resin or the like in order to fix or hold a plurality of power storage devices. For example, PTL 1 teaches, as an example of a power storage module, a battery block including a plurality of cylindrical batteries, a battery holder including a plurality of containers for accommodating the cylindrical batteries, and a pair of terminal plates for electrically connecting the cylindrical batteries.

### CITATION LIST

### Patent Literature

PTL 1: WO 2018/003468 A

### SUMMARY OF THE INVENTION

### Technical problem

In a power storage module including a plurality of power storage devices, when an abnormality occurs in one of the power storage devices, it is an important problem to suppress a thermal influence such as catching fire on other batteries. On the other hand, it is also required to reduce the weight and volume of the entire power storage module and to improve an energy density of the power storage module.

As a method for improving the energy density of the power storage module while suppressing the thermal influence on the adjacent power storage devices, it is conceivable to reduce a distance between the adjacent power storage devices and precisely regulate the distance. However, when a distance between adjacent cylindrical batteries is regulated by a holder provided with walls interposed between the adjacent power storage devices, the walls need to be made thinner. When the wall becomes thinner, it becomes difficult to maintain dimensional accuracy, and there is a possibility that the manufacturing cost of the power storage module is increased. Furthermore, since the strength of the wall also decreases, there is a possibility that the reliability of the power storage module decreases.

### Solutions to problem

One aspect of the present disclosure relates to a power storage module including: a plurality of power storage devices; and a holder that holds the plurality of power storage devices, wherein each of the power storage devices includes a case including an opening, an electrode assembly accommodated in the case and including a first electrode and a second electrode, and a sealing member that seals the opening, the case includes a cylindrical cylinder part, an opening end part corresponding to the opening provided at one end part of the cylinder part, and a bottom part that closes another end part of the cylinder part, in each of the plurality of power storage devices, at least a part of an outer peripheral surface of the cylinder part is covered with an insulating layer, and positions of a pair of the power storage devices adjacent to each other included in the plurality of power storage devices are regulated by the insulating layer.

### Advantageous effect of invention

According to the present disclosure, it is possible to improve an energy density while maintaining reliability of a power storage module.

### BRIEF DESCRIPTION OF THE DRAWINGS

FIG. 1 is an exploded perspective view of a power storage module according to an exemplary embodiment of the present disclosure.

FIG. 2 is a perspective view of an example of a power storage device including an insulating layer.

FIG. 3A is a plan view of the power storage device of FIG. 1.

FIG. 3B is a cross-sectional view taken along line B-B in FIG. 3A.

FIG. 4 is an enlarged view of a part of FIG. 3B.

FIG. 5 is a perspective view of one holder included in the power storage module of FIG. 1.

FIG. 6A is a plan view of the holder of FIG. 5.

FIG. 6B is a cross-sectional view taken along line B-B in FIG. 6A.

FIG. 7 is an exploded perspective view of a power storage module according to another exemplary embodiment of the present disclosure.

FIG. 8 is a perspective view of another example of a power storage device including an insulating layer.

FIG. 9A is a plan view of the power storage device of FIG. 7.

FIG. 9B is a cross-sectional view taken along line B-B in FIG. 9A.

FIG. 10 is an enlarged view of a part of FIG. 9B.

FIG. 11 is a perspective view of one holder included in the power storage module of FIG. 7.

FIG. 12A is a plan view of the holder of FIG. 11.

FIG. 12B is a cross-sectional view taken along line B-B in FIG. 12A.

FIG. 13A is a side view of a power storage device provided with an insulating layer in which a cross section of still another example of the insulating layer is illustrated.

FIG. 13B is a side view of a power storage device provided with an insulating layer in which a cross section of still another example of the insulating layer is illustrated.

### DESCRIPTION OF EMBODIMENT

A power storage module according to one aspect of the present disclosure includes a plurality of power storage devices and a holder that holds the plurality of power storage devices. Each of the power storage devices includes a case having an opening, an electrode assembly accommodated in the case and including a first electrode and a second electrode, and a sealing member that seals the opening. The case includes a cylindrical cylinder part, an opening end part corresponding to the opening provided at one end part of the cylinder part, and a bottom part that closes the other end part of the cylinder part. The shape of the case may be, for example, a cylindrical shape, but is not particularly limited.

Here, in each of the plurality of power storage devices, at least a part of an outer peripheral surface of the cylinder part is covered with an insulating layer. Positions of a pair of the power storage devices adjacent to each other are regulated by the insulating layers. For example, at least a part of the cylinder part of the case may be covered with each of the insulating layers provided along an entire circumference of the outer peripheral surface of the cylinder part. In this case, the insulating layer provided along the entire circumference of the outer peripheral surface of the cylinder part of the case of one power storage device is prevented from coming into contact with an outer peripheral surface of a cylinder part of a case of another power storage device. The insulating layer plays a role similar to that of a wall surface of the holder that regulates a distance between the power storage devices.

Here, “regulation” means that a minimum distance between the power storage devices is secured. The insulating layers may be in constant contact with each other, or may or may not be in contact with each other according to movement of the power storage devices caused by vibration, impact, or the like. When the insulating layers of at least one pair of power storage devices adjacent to each other are in contact with each other, the total thickness of the two insulating layers included in each of the pair of power storage devices may coincide with the minimum distance between the power storage devices. At this time, a volume energy density of the power storage module is further increased. Further, since the insulating layer is supported by the power storage device, the strength of the insulating layer is improved as compared with a wall of the holder that is self-supported and has the same thickness as the insulating layer. Therefore, with the same strength, the insulating layer can be made thinner than the self-supported wall.

When the insulating layers of at least one pair of power storage devices adjacent to each other are in contact with each other, the insulating layers do not need to adhere to each other. Accordingly, each power storage device can be easily assembled to or removed from the power storage module. Therefore, rework in manufacturing the power storage module and maintenance after manufacturing the power storage module are facilitated. However, there is no significant problem even if the insulating layers of at least one pair of power storage devices adjacent to each other adhere to each other, and the insulating layers may adhere to each other. By bonding, it is possible to easily align the pair of adjacent power storage devices.

The holder may have a first wall part facing one end part of the cylinder part and a second wall part facing the other end part of the cylinder part. For example, the holder may include a first holder including the first wall part and a second holder including the second wall part. In this case, the first holder is disposed at one end part of an assembly of the plurality of power storage devices. Further, the second holder is disposed at the other end part of the assembly of the plurality of power storage devices.

The first holder and the second holder may cooperate to serve to integrally hold the plurality of power storage devices. Specifically, at least one of the first holder and the second holder may have, for example, a side wall that surrounds and bundles an assembly of a plurality of power storage devices. The first wall part and the second wall part serve as a floor member or a ceiling member that prevents the power storage devices from jumping out from one end part and the other end part of the assembly of the plurality of power storage devices, respectively. The first wall part and the second wall part (floor member or ceiling member) usually have through-holes corresponding to positions of the power storage devices.

The insulating layer covers, for example, 50% or more, or 80% or more of the outer peripheral surface of the cylinder part. As a result, contact between the power storage devices is more highly suppressed.

At least one of the first wall part and the second wall part may have a plurality of support parts protruding from the first wall part or the second wall part (floor member or ceiling member) and arranged around the cylinder part. Such support parts have a function of temporarily fixing the power storage devices at the time of assembling the power storage module to prevent the power storage devices from falling sideways, for example. In the holder having the support parts, a back surface of a surface on which the support parts are formed may be recessed. With this configuration, the weight of the holder can be reduced. Further, in order to reduce the weight, through-holes extending in a direction in which the support parts protrude may be formed in the support parts.

The dimension of each of the support parts may be larger than the sum of the thicknesses of the insulating layers formed in each of the pair of adjacent power storage devices in a direction (in other words, a radial direction) perpendicular to the circumferential direction of the cylinder part of the power storage device. In this case, each of the support parts cannot be interposed in the narrowest space between the pair of power storage devices. With this configuration, when the insulating layers of at least one pair of power storage devices adjacent to each other are positioned to face each other, the positioning can be performed while suppressing the influence of the dimension of each of the support parts, and each power storage device can be fixed.

When a part of the outer peripheral surface of the cylinder part of the case is not covered with the insulating layer, a part not covered with the insulating layer may be adjacent to a part of at least one of the first holder and the second holder. At this time, a part of the first holder or the second holder adjacent to the outer peripheral surface of the cylinder part of the case may be, for example, a support part protruding from the first wall part or the second wall part (floor member or ceiling member). That is, the insulating layer may not be formed in a region facing the support part on the outer peripheral surface of the cylinder part. With this configuration, an amount of the insulating layer provided in each power storage device can be reduced. Further, since the holder and the power storage device can face each other without the insulating layer interposed therebetween, the power storage module can be downsized by the thickness of the insulating layer as compared with the configuration in which the insulating layer is interposed between the holder and the power storage device. Alternatively, an insulating layer thinner than the insulating layer in the region not facing the support part may be formed in the region facing the support part on the outer peripheral surface of the cylinder part. With this configuration, the power storage module can be downsized by a difference in thickness of the insulating layers between the region not facing the support part and the region facing the support part. Furthermore, a creepage distance can be extended by providing an insulating layer also in a region facing the support part on the outer peripheral surface of the cylinder part.

The insulating layer may be divided into a plurality of regions on the outer peripheral surface of the cylinder part. At this time, in the region between the plurality of regions, a part of the outer peripheral surface of the cylinder part may be exposed over the entire circumference. In other words, the insulating layer may have a plurality of ring shapes, and the outer peripheral surface of the cylinder part may be exposed in a ring shape. This can reduce a required amount of the insulating layer.

The insulating layer may also be provided on an outer surface of the bottom part of the case. In this case, even when the power storage devices move due to vibration, impact, or the like, contact between the bottom parts of the cases is suppressed. In this case, the structure of the second holder disposed at an end part near the bottom part of the case of the assembly of the plurality of power storage devices can be further simplified. For example, it is less necessary to provide the second wall (floor member) of the second holder with a support part adjacent below the outer surface of the cylinder part of the case. Further, it is also possible to provide a hole in the support part, through which the insulating layer of the bottom part is exposed, to reduce the weight of the support part.

The plurality of power storage devices may be arranged side by side. Arranging the plurality of power storage devices side by side means, for example, that axial directions of the electrode assemblies of the plurality of power storage devices are substantially parallel, one and the other end parts of the assembly of the plurality of power storage devices are positioned in substantially the same plane, and the cylinder parts of the cases of the power storage devices are arranged so as to be adjacent to each other.

The plurality of power storage devices may be arranged side by side such that the cases face the same direction. In this case, the sealing members of the plurality of power storage devices are positioned substantially in the same plane. The power storage module usually includes a first current collector having the same polarity as one polarity of the plurality of power storage devices, and a second current collector having the same polarity as the other polarity. When the cases of the plurality of power storage devices are arranged side by side so as to face the same direction, it is easy to collectively dispose both the first current collector and the second current collector near one end part (specifically, a side having the sealing member) of the power storage devices, so that it is not necessary to provide a current collecting structure near the other end part (specifically, a side of the bottom part) of the power storage devices. Therefore, it is possible to reduce the space required by the power storage devices in the axial direction, which is advantageous for improving the volume energy density of the power storage module.

The electrode assembly is configured by, for example, winding a first electrode and a second electrode with a separator interposed therebetween. When the power storage device is a battery, one of the first electrode and the second electrode is a positive electrode, and the other is a negative electrode. Further, one of the first current collector and the second current collector is a positive electrode current collector, and the other is a negative electrode current collector.

Note that the type of the power storage device is not particularly limited, and examples thereof include a primary battery, a secondary battery, a lithium ion capacitor, an electric double layer capacitor, and a solid electrolytic capacitor. Among them, a non-aqueous electrolyte secondary battery (including an all-solid-state battery) such as a lithium ion secondary battery having a high energy density can be suitably used.

A thickness of the insulating layer may be appropriately selected depending on a size of the power storage device, the equipment on which the power storage device is mounted, and the like, but may be, for example, 0.5 mm or less, and further 0.2 mm or less in the form of a film from the viewpoint of taking advantage of making tolerance smaller than that of the holder, for example.

The first holder may be fixed to at least a part of one end part of the assembly of the plurality of power storage devices with an adhesive. Similarly, the second holder may be fixed to at least a part of the other end part of the assembly of the plurality of power storage devices with an adhesive. As a result, the integration of the power storage module is enhanced, and the movement of the power storage devices due to vibration, impact, or the like is suppressed. Therefore, contact between the power storage devices is less likely to occur, and higher safety can be easily secured.

The insulating layer may be a cured product of a curable resin composition. In this case, the insulating layer is formed, for example, by applying the curable resin composition before curing to the outer peripheral surface of the cylinder part of the case using a roller or the like and then curing the composition. The curable resin composition may contain a thermosetting resin that cures at a low temperature, or may contain a photocurable resin that cures by irradiation with light such as UV light. Alternatively, the insulating layer may be a molded article formed in advance in a cylindrical shape or in a cap shape covering the cylinder part and the bottom part of the case. The molded article desirably has elasticity so as to be easily fitted into the case. Silicone, polyurethane and the like may be contained, and a rubber component may be contained. Further, in addition to the curable resin composition, the insulating layer may be formed by applying a liquid obtained by dissolving or dispersing an insulator in a solvent to the cylinder part and removing the solvent by drying.

The curable resin composition may contain particles containing an inorganic substance that decomposes by an endothermic reaction. As an example of such an inorganic substance, a metal hydroxide such as aluminum hydroxide or magnesium hydroxide may be used. Examples of particles containing an inorganic substance include an inorganic filler composed of the metal hydroxide as described above. Aluminum hydroxide, magnesium hydroxide, and the like decompose at a high temperature (for example, a temperature higher than 200° C.) to release water vapor. Since this decomposition reaction is an endothermic reaction, an ambient temperature is lowered. Therefore, the safety of the power storage module at the time of abnormality can be highly enhanced.

When the curable resin composition contains an inorganic filler, the content of the inorganic filler is not particularly limited, and may be, for example, 10 mass % or more and 90 mass % or less, or 20 mass % or more and 80 mass % or less.

Hereinafter, a power storage module according to an exemplary embodiment of the present invention will be specifically described with reference to the drawings, but the present invention is not limited thereto.

### First Exemplary Embodiment

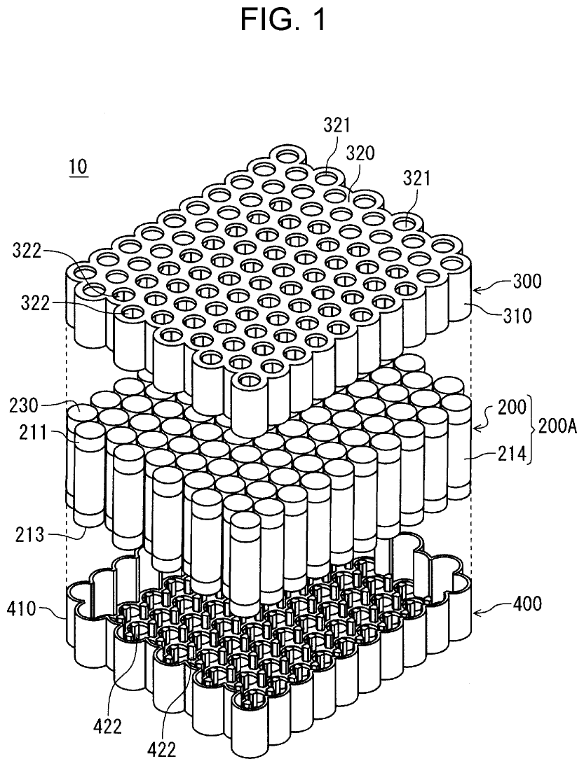

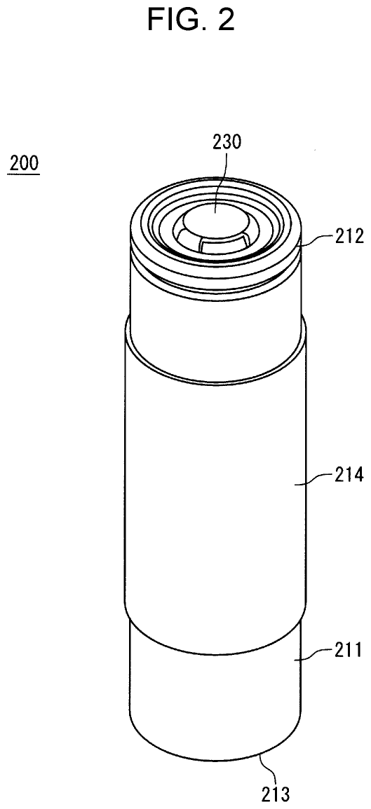

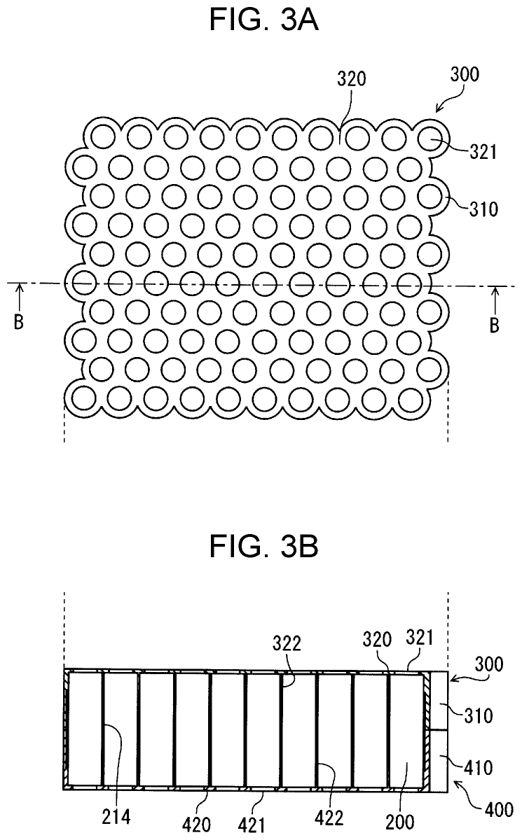

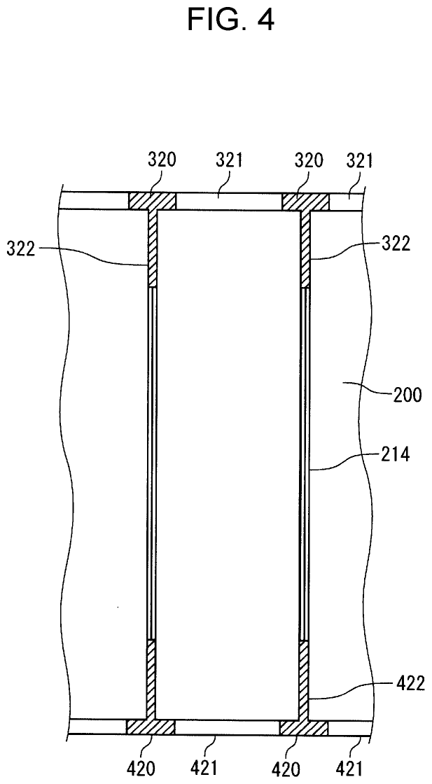

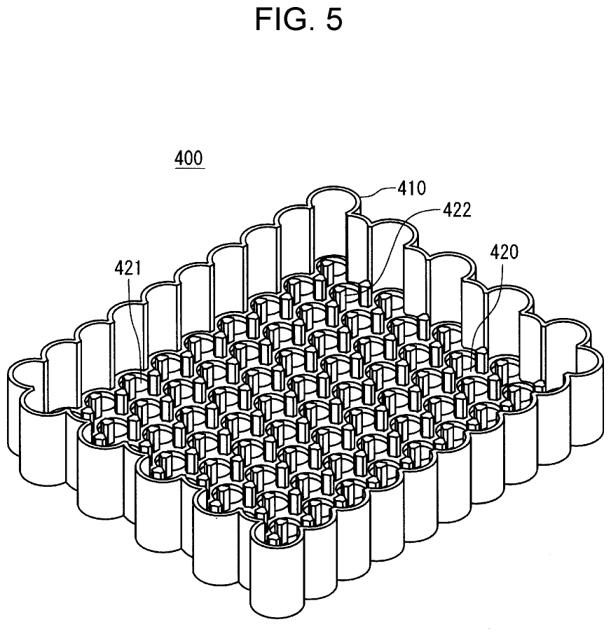

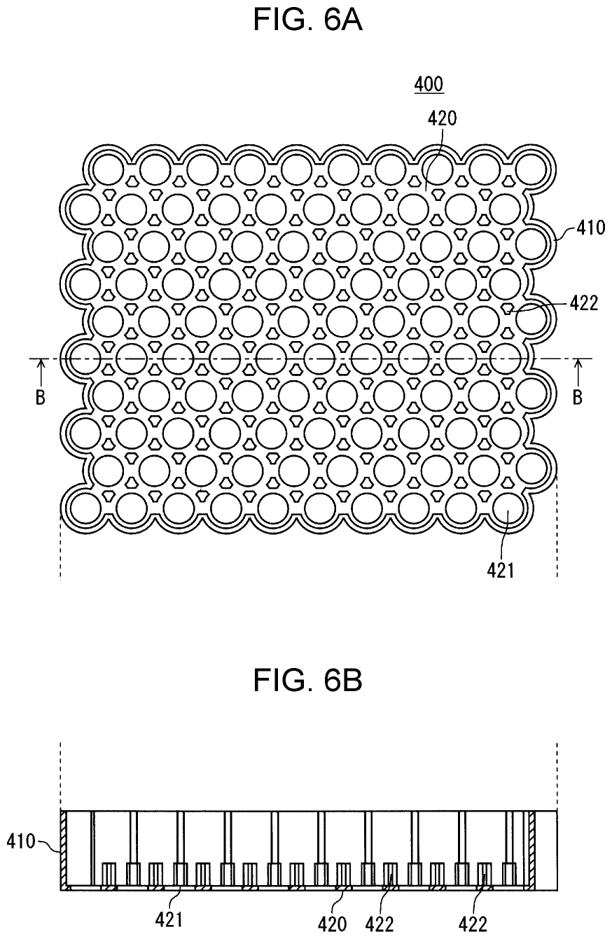

FIG. 1 is an exploded perspective view of a power storage module according to an exemplary embodiment of the present disclosure. FIG. 2 is a perspective view of an example of a power storage device including an insulating layer mounted on the power storage module of FIG. 1. FIG. 3A is a plan view of the power storage device of FIG. 1, FIG. 3B is a cross-sectional view taken along line B-B of FIG. 3A, and FIG. 4 is an enlarged view of a part of FIG. 3B. FIG. 5 is a perspective view of one holder included in the power storage module of FIG. 1, FIG. 6A is a plan view of the holder of FIG. 5, and FIG. 6B is a cross-sectional view taken along line B-B of FIG. 6A.

Power storage module 10 includes a plurality of cylindrical power storage devices 200, and first holder 300 and second holder 400 that integrally hold the plurality of power storage devices 200. The plurality of power storage devices 200 are arranged side by side such that the cases face the same direction.

In FIG. 1, 100 power storage devices are arranged in a staggered manner so as to be close to close-packed packing, but the arrangement, number, and the like of the power storage devices are not particularly limited. First holder 300 is disposed at one end part (an upper end part in FIG. 1) of assembly 200A of the plurality of power storage devices 200. Second holder 400 is disposed at the other end part (a lower end part in FIG. 1) of assembly 200A of the plurality of power storage devices 200.

As illustrated in FIG. 2, each of power storage devices 200 includes case 210 having an opening, an electrode assembly (not illustrated) accommodated in case 210, and sealing member 230 fixed to case 210 so as to seal the opening. Case 210 includes cylinder part 211, opening end part 212 corresponding to the opening provided at one end part of cylinder part 211, and bottom part 213 that closes the other end part of cylinder part 211. In FIGS. 1, 3, and 4, the structure of case 210 is illustrated in a simplified manner. The shape of case 210 is cylindrical in the illustrated example, but is not particularly limited.

An outer peripheral surface of a region including a central part of cylinder part 211 of case 210 is covered with insulating layer 214 for ensuring insulating properties along an entire circumference. Insulating layer 214 has a film shape having a predetermined thickness (for example, about 0.5 mm to 1.0 mm). Here, an area of the region including the central part is about 50% to 60% of the outer peripheral surface of the cylinder part. End part regions of cylinder part 211 near the opening and near bottom part 213 are not covered with insulating layer 214, and case 210 is exposed.

A material of insulating layer 214 is not particularly limited as long as it has insulating properties, but it is desirable that the insulating layer has heat resistance, and it is more preferable that the insulating layer has heat absorbing properties. Examples of such a material include the cured product of the curable resin composition described above, but other thermosetting elastomers such as urethane rubber and silicone rubber may be used. For example, case 210 may be inserted into a ring-shaped elastomer.

An electrode assembly (not illustrated) generally includes a first electrode having a first polarity, a second electrode having a second polarity, and a separator interposed therebetween. In the case of cylindrical power storage device 200 as illustrated in FIG. 2, the first electrode and the second electrode are generally wound with a separator interposed therebetween to form a columnar electrode assembly. Since the first electrode is connected to sealing member 230, sealing member 230 has the same polarity as that of the first electrode. On the other hand, since the second electrode is electrically connected to case 210, case 210 has the same polarity as that of the second electrode.

As illustrated in FIG. 4, insulating layers 214 of the pair of power storage devices 200 adjacent to each other are in contact with each other, and the thickness of insulating layer 214 regulates a distance between power storage devices 200. Therefore, both first holder 300 and second holder 400 do not need to have a member for firmly fixing the power storage devices by being interposed in a gap where the plurality of power storage devices 200 are in closest contact with each other. Such first holder 300 and second holder 400 can be easily manufactured at low cost with a small tolerance. Further, in the present exemplary embodiment, insulating layer 214 has a function of positioning the plurality of power storage devices 200, and can suppress contact between cases 210 of the pair of power storage devices 200 adjacent to each other. With such a structure, since the distance between power storage devices 200 can be easily reduced, the energy density of power storage module 10 can be easily increased.

In FIG. 4, insulating layers 214 of adjacent power storage devices 200 are in contact with each other, but are not necessarily in contact without a gap. In addition, insulating layers 214 of adjacent power storage devices 200 may or may not adhere to each other.

First holder 300 and second holder 400 are disposed so as to sandwich and accommodate assembly 200A of the plurality of power storage devices 200 from above and below. Accordingly, first holder 300 and second holder 400 cooperate with each other to ensure the integrity of assembly 200A of the plurality of power storage devices 200.

Specifically, first holder 300 and second holder 400 have side walls 310 and 410 that surround and bundle an upper half and a lower half of assembly 200A of the plurality of power storage devices 200, respectively. Here, the upper half of assembly 200A means a half near sealing member 230 (near opening end part 212 of case 210) of each of the plurality of power storage devices 200, and the lower half means a half near bottom part 213 of each of the plurality of power storage devices 200. Further, first holder 300 includes ceiling member 320 that prevents power storage device 200 from jumping out from an end part of assembly 200A near sealing member 230. Ceiling member 320 corresponds to a first wall part facing one end part of the cylinder part of the power storage device. On the other hand, second holder 400 includes floor member 420 that prevents power storage device 200 from jumping out from an end part of assembly 200A near bottom part 213. Floor member 420 corresponds to a second wall part facing the other end part of the cylinder part. Ceiling member 320 includes a plate-shaped member disposed so as to connect end parts near sealing member 230 of side wall 310 near an upper half side of assembly 200A. Floor member 420 includes a plate-shaped member disposed so as to connect end parts near bottom part 213 of side wall 410 near a lower half side of the assembly 200A.

The plate-shaped member of ceiling member 320 is provided with first through-hole 321 corresponding to a position of power storage device 200, and the plate-shaped member of floor member 420 is provided with second through-hole 421 corresponding to a position of power storage device 200. Each of the through-holes is located immediately above sealing member 230 and immediately below bottom part 213 of each of the plurality of power storage devices 200. First through-hole 321 is used for construction of a current collecting structure via case 210 or sealing member 230. Further, for example, first through-hole 321 plays a role of guiding gas discharged from power storage device 200 at the time of abnormality to a predetermined duct. For example, second through-hole 421 can function as an exhaust heat path for releasing heat generated in power storage device 200. When second through-hole 421 is used as the exhaust heat path, a heat dissipation member (heat dissipation plate, heat dissipation fin, and the like) may be provided on an outer surface of floor member 420, and second through-hole 421 interposed between the heat dissipation member and power storage device 200 may be filled with a heat transfer material. Since the heat transfer material is thermally connected to power storage device 200 and the heat dissipation member, exhaust heat from power storage device 200 can be promoted. Further, by forming an explosion-proof valve in bottom part 213 of case 210, second through-hole 421 can be used as an exhaust path similarly to first through-hole 321.

First holder 300 and second holder 400 can be obtained by, for example, transfer molding of a curable resin composition or injection molding of a thermoplastic resin.

As illustrated in FIG. 1, FIG. 5, FIG. 6A, and FIG. 6B, support parts 322 and 422 disposed in a gap between power storage devices 200 may protrude from ceiling member 320 of first holder 300 and floor member 420 of second holder 400. The plurality of support parts 322, 422 are disposed around the cylinder part of the power storage device in a state of being separated from each other. However, the dimensions of support parts 322, 422 are larger than the sum of the thicknesses of the insulating layers formed in the pair of adjacent power storage devices in the direction perpendicular to the circumferential direction of cylinder part 211 of case 210 of power storage device 200 (in other words, the radial direction of the cylinder part). Therefore, support parts 322, 422 are prevented from being interposed in a gap or a space formed when the power storage devices are brought into close contact with each other.

On the outer peripheral surface of cylinder part 211 of case 210 of power storage device 200, insulating layer 214 is not necessarily formed in a region facing support parts 322, 422. End part regions of cylinder part 211 of case 210 near the opening and near bottom part 213 are not covered with insulating layer 214, and case 210 is exposed. Support parts 322 and 422 are adjacent to a region where case 210 is exposed, and contribute to fixing of power storage device 200. Support parts 322 and 422 also have a function of preventing power storage device 200 from falling sideways when power storage module 10 is assembled. The cross-sectional shapes of support parts 322 and 422 may be polygonal shapes such as hexagonal shapes or circular shapes according to a shape of the gap surrounded by power storage device 200. Further, a figure including a plurality of arcs (for example, six arcs) recessed inward in accordance with the shape of the peripheral surface of the cylinder part may be used. A height of the support part is approximately 10% to 25% of a height of the power storage device. It should be noted that support parts 322 and 422 are not essential and are provided arbitrarily.

First holder 300 may be fixed to at least a part of one end part (on the side of sealing member 230) of assembly 200A of the plurality of power storage devices 200 with an adhesive. For example, assembly 200A may be covered with first holder 300 after the adhesive is applied to opening end part 212 of case 210 or a peripheral edge part of sealing member 230. Similarly, second holder 400 may be fixed to at least a part of the other end part (on the side of bottom part 213 of case 210) of assembly 200A of the plurality of power storage devices 200 with an adhesive. For example, power storage device 200 may be disposed on second holder 400 after the adhesive is applied to a peripheral edge part of bottom part 213 of case 210. Ceiling member 320 of first holder 300 may have a third through-hole (not illustrated) different from first through-hole 321 in a part facing the end part near the opening of each power storage device. The third through-hole can be used as a current collection path of the second electrode. At this time, a current collecting plate for the second electrode may be provided on an outer surface side of ceiling member 320. A lead may be inserted into the third through-hole from the current collecting plate such that the end part near the opening of case 210 of each power storage device 200 is connected to the current collecting plate for the second electrode. Note that the third through-hole may be integrated with first through-hole 321 to form one through-hole.

### Second Exemplary Embodiment

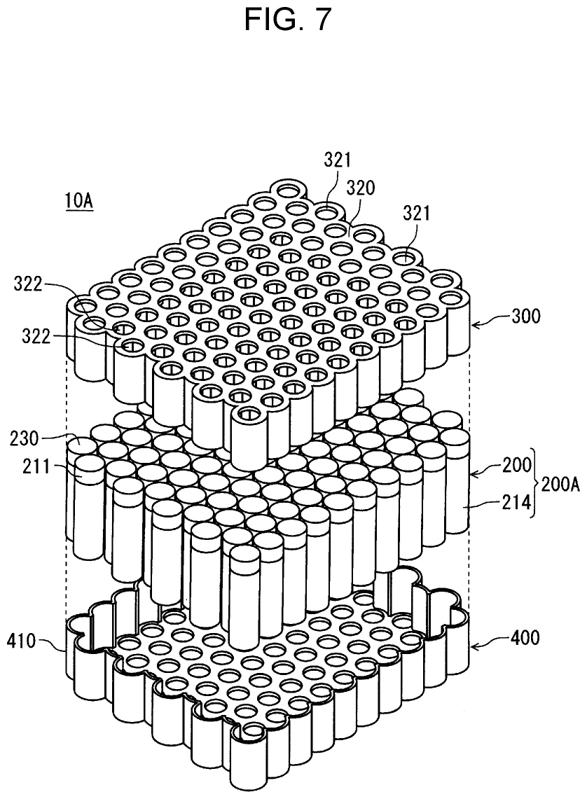

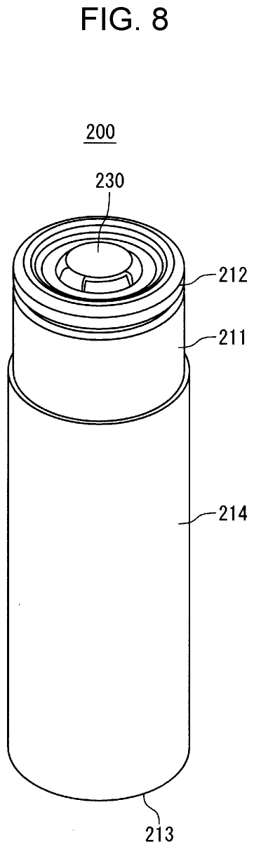

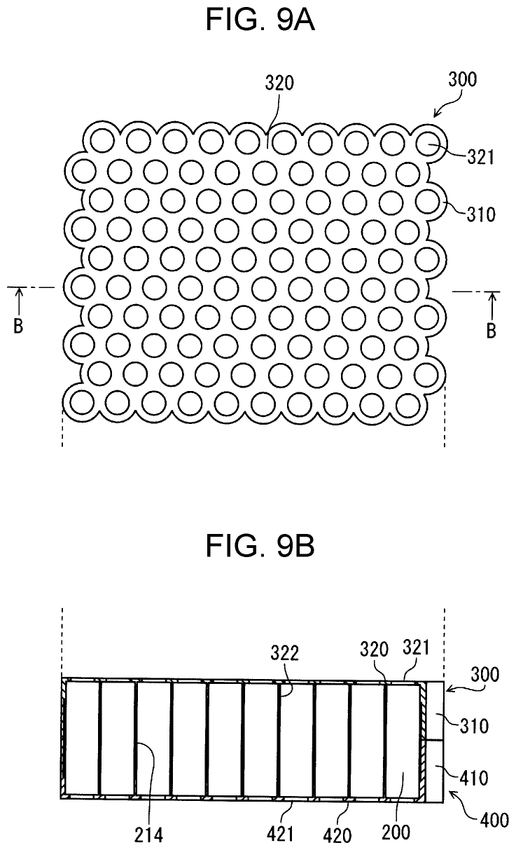

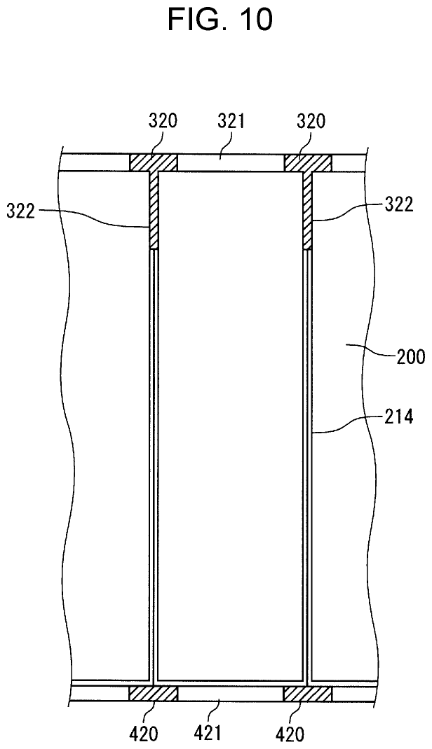

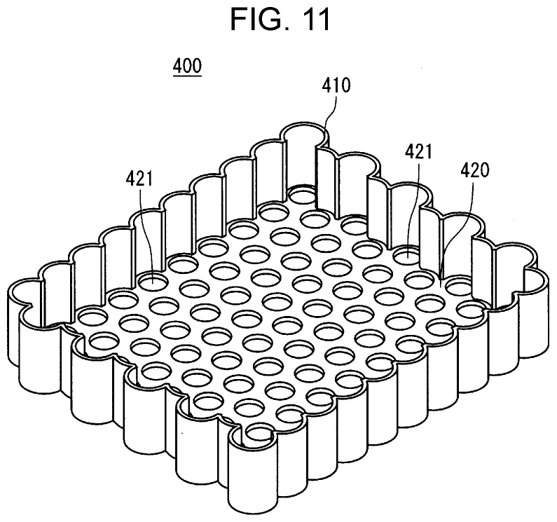

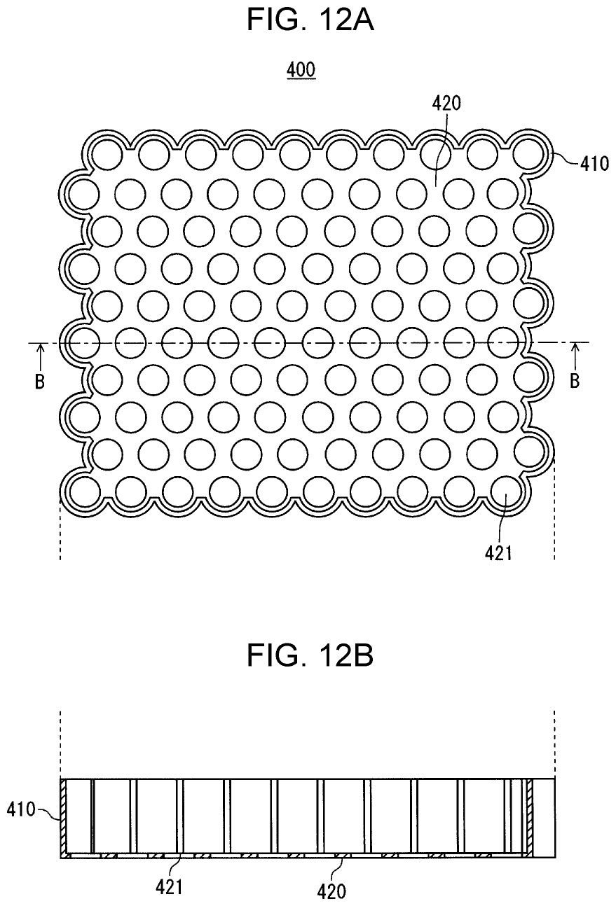

FIG. 7 is an exploded perspective view of a power storage module according to another exemplary embodiment of the present disclosure. FIG. 8 is a perspective view of an example of a power storage device including an insulating layer mounted on the power storage module of FIG. 7. FIG. 9A is a plan view of the power storage device of FIG. 7, FIG. 9B is a cross-sectional view taken along line B-B of FIG. 9A, and FIG. 10 is an enlarged view of a part of FIG. 9B. FIG. 11 is a perspective view of one holder included in the power storage module of FIG. 7, FIG. 12A is a plan view of the holder of FIG. 11, and FIG. 12B is a cross-sectional view taken along line B-B of FIG. 12A. The same reference marks are used for the same or corresponding configuration elements as those in the first exemplary embodiment.

Power storage module 10A according to the present exemplary embodiment has the same configuration as that of the first exemplary embodiment except that an aspect of insulating layer 214 included in a plurality of power storage devices 200 and a structure of second holder 400 are different. Specifically, in the present exemplary embodiment, insulating layer 214 is also provided on an outer surface of a bottom part of case 210. Further, floor member 420 of second holder 400 does not include support part 422 disposed in a gap between power storage devices 200. Such power storage module 10A can be manufactured at lower cost since the manufacturing cost of second holder 400 is lower. Further, the weight of the power storage module can be reduced.

Insulating layer 214 covering case 210 from cylinder part 211 to bottom part 213 can be formed by, for example, dipping a region from near bottom part 213 of power storage device 200 to a front side of opening end part 212 of cylinder part 211 in a precursor coating material of insulating layer 214. As the precursor coating material of insulating layer 214, a curable resin composition before curing, a thermoplastic resin diluted with a solvent, or the like can be used. When power storage device 200 is dipped into the thermoplastic resin diluted with the solvent, the solvent is removed by drying. Further, insulating layer 214 may be formed by fitting a resin molded article formed in a cap shape covering cylinder part 211 and bottom part 213 of case 210 into case 210.

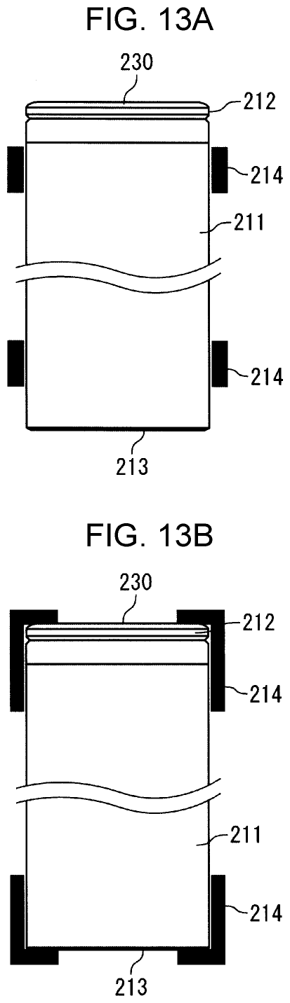

An aspect of insulating layer 214 is not limited to the first and second exemplary embodiments, and various aspects are conceivable. For example, as illustrated in FIG. 13A, ring-shaped insulating layer 214 may be provided by being divided into a plurality of regions on the outer peripheral surface of the cylinder part. In this case, in the region between the plurality of regions, a part of the outer peripheral surface of cylinder part 211 is exposed over the entire circumference. Therefore, an amount of insulating layer 214 used can be reduced, and a large gap can be formed between the plurality of power storage devices 200, so that the heat dissipation of the power storage module can be improved. Further, insulating layer 214 is not necessarily formed on the entire circumference of the cylinder part. The insulating layer may be formed in a region facing a space where a distance between at least a pair of adjacent power storage devices is shortest on an outer side surface of the cylinder part. Therefore, a plurality of insulating layers may be intermittently formed in the circumferential direction of the cylinder part. A part of the support part may be fitted to a region where an insulating layer is not formed between the adjacent insulating layers formed at a plurality of locations. As a result, rotation of the power storage device can be suppressed.

Further, the insulating layer may be formed in a C shape with respect to the cylinder part when the power storage device is viewed in a plan view. Furthermore, a cutout may be formed on the lower end side or the upper end side of the cylindrical insulating layer, and the support part may be locked to the cutout.

Further, as illustrated in FIG. 13B, a pair of caps covering one and the other end parts of power storage device 200 and the peripheral edge parts of the end surfaces may be used as insulating layer 214. Since such insulating layer 214 is easily manufactured and is easily attached to power storage device 200, the manufacturing cost of the power storage module can be effectively reduced.

Although the cylindrical power storage device has been described above as an example, the present disclosure can also be used for power storage devices having various shapes (for example, prisms).

### INDUSTRIAL APPLICABILITY

The power storage module according to the present disclosure can be used for various power storage devices, and is particularly suitable for use as a power source for vehicles such as hybrid vehicles and electric vehicles.

### REFERENCE MARKS IN THE DRAWINGS

10, 10A: power storage module

200: power storage device

200A: assembly

210: case

211: cylinder part

212: opening edge

213: bottom part

214: insulating layer

230: sealing member

300: first holder

310: side wall

320: ceiling member (first wall part)

321: first through-hole

322: support part

400: second holder

410: side wall

420: floor member (second wall part)

421: second through-hole

422: support part

1. A power storage module comprising:
a plurality of power storage devices; and
a holder that holds the plurality of power storage devices,
wherein each of the power storage devices includes
a case including an opening,
an electrode assembly accommodated in the case and including a first electrode and a second electrode, and
a sealing member that seals the opening,
the case includes
a cylindrical cylinder part,
an opening end part corresponding to the opening provided at one end part of the cylinder part, and
a bottom part that closes another end part of the cylinder part,
in each of the plurality of power storage devices, at least a part of an outer peripheral surface of the cylinder part is covered with an insulating layer, and
positions of a pair of the power storage devices adjacent to each other included in the plurality of power storage devices are regulated by the insulating layer of the pair of the power storage devices.

2. The power storage module according to claim 1, wherein the insulating layer of at least the pair of the power storage devices adjacent to each other are in contact with each other.

3. The power storage module according to claim 2, wherein the insulating layer of at least the pair of power storage devices adjacent to each other are in contact with each other but are not adhered to each other.

4. The power storage module according to claim 1, wherein the holder includes a first wall part facing one end part of the cylinder part and a second wall part facing the other end part of the cylinder part.

5. The power storage module according to claim 4, wherein the holder includes a first holder including the first wall part and a second holder including the second wall part.

6. The power storage module according to claim 4, wherein at least one of the first wall part and the second wall part includes a plurality of support parts disposed around the cylinder part.

7. The power storage module according to claim 6, wherein a dimension of each of the plurality of support parts is larger than a sum of thicknesses of the insulating layer in the pair of adjacent power storage devices, respectively, in a direction perpendicular to a circumferential direction of the cylinder part of each of the plurality of power storage devices.

8. The power storage module according to claim 6, wherein each of the plurality of support parts is not interposed in a narrowest space between the pair of power storage devices.

9. The power storage module according to claim 6, wherein on the outer peripheral surface of the cylinder part, the insulating layer is not in a region facing each of the plurality of support parts, or an insulating layer is thinner than the insulating layer in a region not facing each of the plurality of support parts.

10. The power storage module according to claim 1, wherein the insulating layer is divided into a plurality of regions on the outer peripheral surface of the cylinder part, and a part of the outer peripheral surface of the cylinder part is exposed over an entire circumference in a region between the plurality of regions.

11. The power storage module according to claim 1, wherein the insulating layer is also provided on an outer surface of the bottom part.

12. The power storage module according to claim 1, wherein the plurality of power storage devices are arranged side by side, the case included in each of the power storage devices facing an identical direction.

13. The power storage module according to claim 1, wherein the insulating material is a cured product of a curable resin composition.

14. The power storage module according to claim 13, wherein
the curable resin composition contains an inorganic filler, and
the inorganic filler includes an endothermic property at higher than or equal to a predetermined temperature.
